(19) United States
(12) Patent Application Publication
(10) Pub. No.: US 2010/0051136 A1
(43) Pub. Date: Mar. 4, 2010

(54) Cleaning and fluid dispensing device

(76) Inventor: Max Weber, IV, El Paso, TX (US)

Correspondence Address: JAMES RAY & ASSOCIATES, 2640 PITCAIRN ROAD, MONROEVILLE, PA, 15146, US

(21) Appl. No.: 12/229,693

(22) Filed: Aug. 26, 2008

(51) Int. Cl. B67D 5/06

(52) U.S. Cl. 141/89

(57) ABSTRACT

The present invention provides a cleaning and fluid dispensing device. Such cleaning and fluid dispensing device includes a housing member. A first plurality of brush bristles is operably connected to such housing member at a first predetermined location thereon. A handle member is operably connected to such housing member at a second predetermined location thereon. A reservoir for storing a predetermined amount of a predetermined fluid is disposed within at least one of such housing member, such handle member and a combination thereof. An access mechanism is in fluid communication with such reservoir and operably connected to at least one of such housing member and such handle member at a third predetermined location thereon for selectively accessing such reservoir such that such reservoir may be at least one of filled, emptied, refilled and a combination thereof.

### FIELD OF THE INVENTION

The present invention relates, in general, to cleaning devices and, more particularly, this invention relates to a cleaning device which may also be used to dispense fluid.

### BACKGROUND OF THE INVENTION

Prior to the conception and development of the present invention, cleaning devices, as are generally well known in the prior art, have been used to clean various items such as machinery, automobile parts, tools, and the like. Many articles and items such as hammer joints, pup joints, swing joints, iron assemblies, hose assemblies, o-ring assemblies, unions, wings, and threads, particularly those in the oil industry, need to be both cleaned and lubricated. However, such tasks are not enjoyable and can be difficult and time consuming. Often mud, dirt, rocks, and other debris gathers on such items, even caking on at times. Rig up crews, welders, technicians mechanics, and the like lose valuable time and energy attempting to deal with these types of situations. Therefore there is a need for a device which combines both cleaning and dispensing fluid and which is convenient and easy to use.

### SUMMARY OF THE INVENTION

The present invention provides a cleaning and fluid dispensing device. Such cleaning and fluid dispensing device includes a housing member manufactured from a first predetermined material and having a first predetermined size and a first predetermined shape. A first plurality of brush bristles is operably connected to such housing member at a first predetermined location thereon. Such plurality of brush bristles is manufactured from a second predetermined material and has a first predetermined length. A handle member is operably connected to such housing member at a second predetermined location thereon. Such handle member is manufactured from a third predetermined material and has a second predetermined size and a second predetermined shape. A reservoir for storing a predetermined amount of a predetermined fluid is disposed within at least one of such housing member, such handle member and a combination thereof and has a third predetermined size and a third predetermined shape. An access means is in fluid communication with such reservoir and operably connected to at least one of such housing member and such handle member at a third predetermined location thereon for selectively accessing such reservoir such that such reservoir may be at least one of filled, emptied, refilled and a combination thereof.

According to another embodiment, a method of using a cleaning and fluid dispensing device is provided. Such method includes the steps of providing a cleaning and fluid dispensing device including: a housing member manufactured from a first predetermined material and having a first predetermined size and a first predetermined shape; a first plurality of brush bristles operably connected to such housing member at a first predetermined location thereon, such plurality of brush bristles being manufactured from a second predetermined material and having a first predetermined length; a handle member operably connected to such housing member at a second predetermined location thereon, such handle member being manufactured from a third predetermined material and having a second predetermined size and a second predetermined shape; a reservoir for storing a predetermined amount of a predetermined fluid, such reservoir being within at least one of such housing member, such handle member, and a combination thereof and having a fourth predetermined size and a fourth predetermined shape; an access means in fluid communication with such reservoir and operably connected to at least one of such housing member and such handle member at a third predetermined location thereon for selectively accessing such reservoir such that such reservoir may be at least one of filled, emptied, refilled and a combination thereof. Filling such reservoir with such predetermined amount of such predetermined liquid. Brushing a surface of a predetermined item to be cleaned. Dispensing a second predetermined amount of such predetermined liquid on such surface of such predetermined item.

### OBJECTS OF THE INVENTION

It is, therefore, one of the primary objects of the present invention to provide a device which will enable a user to clean and lubricate various joints and assemblies and which may also be utilized as an o-ring remover.

Another object of the present invention is to provide a handheld device which has a reservoir for storing about half a quart of oil which can be dispensed by a user to selectively oil a predetermined item.

Still another object of the present invention is to provide a cleaning device which includes magnets disposed on such device such that the device can be attached to a predetermined metal surface.

Yet another object of the present invention is to provide cleaning and oiling device which promotes less spillage of oil during oiling of a predetermined item thereby reducing pollution and promoting environmentally friendly behavior.

An additional object of the present invention is to provide a device including a wire brush, a non-slip handle, and a refillable reservoir which can be filled with a predetermined fluid and which is capable of releasing predetermined amounts of such predetermined fluid as selectively determined by a user.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

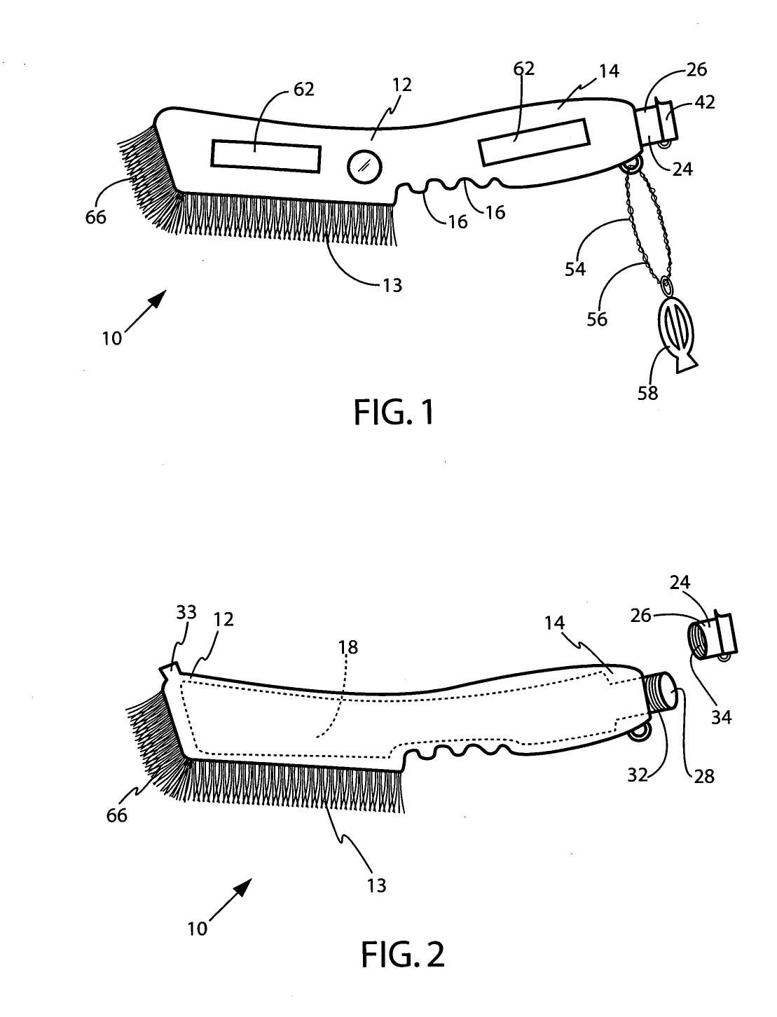

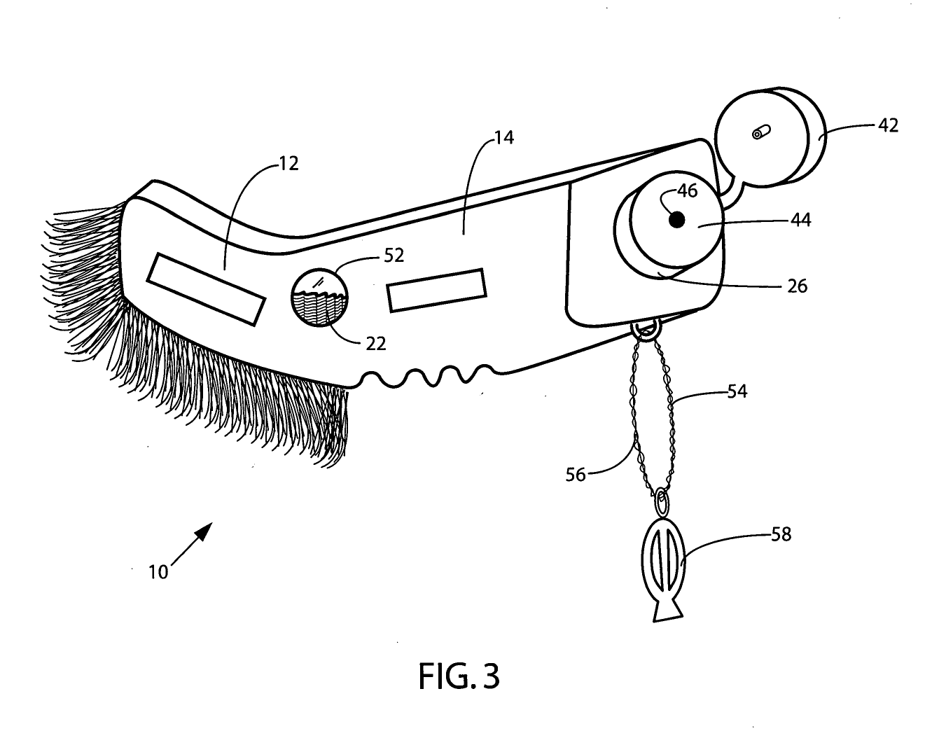

Reference is now made, more particularly, to FIGS. 1-3.

A cleaning and fluid dispensing device, generally designated 10, is provided. Such cleaning and fluid dispensing device 10 includes a housing member 12 manufactured from a first predetermined material and having a first predetermined size and a first predetermined shape. It is presently preferred that such first predetermined material is plastic.

A first plurality of brush bristles 13 is operably connected to such housing member 12 at a first predetermined location thereon. Such plurality of brush bristles 13 is manufactured from a second predetermined material and has a first predetermined length. It is presently preferred that such second predetermined material is metal.

A handle member 14 is operably connected to such housing member 12 at a second predetermined location thereon. Such handle member 14 is manufactured from a third predetermined material and has a second predetermined size and a second predetermined shape. It is presently preferred that such third predetermined material is plastic. It is presently preferred that such handle member 14 includes at least one molded fingergrip 16 at a predetermined location thereon.

It is presently preferred that such first predetermined material and such third predetermined material are substantially identical. It is contemplated that such housing member 12 and such handle member 14 may be formed as one unit, however, the device 10 is not meant to be limited as such and such housing member 12 and such handle member 14 may be formed and joined in any manner which facilitates the purpose of such device 10.

A reservoir 18 for storing a predetermined amount of a predetermined fluid 22 is disposed within at least one of such housing member 12, such handle member 14 and a combination thereof and has a third predetermined size and a third predetermined shape. It is presently preferred that such reservoir 18 extends through a predetermined portion of such housing member 12 and a predetermined portion of such handle member 14. It is presently preferred that such reservoir 18 is sized to hold between about ¼ quart and about ¾ quart of such predetermined fluid. Such fluid may be water, a cleaning fluid, a lubricant, such as oil, a mixture of fluids, or any other fluid or liquid as desired by a user.

An access means 24 is in fluid communication with such reservoir 18 and operably connected to at least one of such housing member 12 and such handle member 14 at a third predetermined location thereon for selectively accessing such reservoir 18 such that such reservoir 18 may be at least one of filled, emptied, refilled and a combination thereof. It is presently most preferred that such access means 24 is disposed on such handle member 14.

It is presently preferred that such access means 24 is a screw on cap 26 and wherein at least one of such handle member 14 and such housing member 12 includes a raised opening 28 being threaded around an outer perimeter 32 thereof and such screw on cap 26 includes a threaded female opening 34 for screwing onto such threaded outer perimeter 32 of such raised opening 28.

It is presently preferred that such screw on cap 26 further includes a flip top cap 42 hingedly connected thereto at a first predetermined location thereon for moving between a closed position generally parallel to such screw on cap 26 wherein a top portion 44 of such screw on cap 26 is covered by such flip top cap 42 and an open position generally perpendicular to such screw on cap 26 wherein such top portion 44 of such screw on cap 26 is uncovered. Such screw on cap 26 further including an aperture 46 disposed through such top portion 44 thereof at a second predetermined location thereon. Such aperture 46 being covered by such flip top cap 42 when such flip top cap 42 is in such closed position such that such predetermined fluid 22 is retained within such reservoir 18 and such aperture 46 being uncovered for dispensing such predetermined fluid 22 there from when such flip top cap 42 is in such open position.

It is presently preferred that at least one of such housing member 12 and such handle member 14 includes a generally transparent member 52 disposed at a fourth predetermined location thereon such that such predetermined fluid 22 is at least partially visible through such generally transparent member 52. Such generally transparent member 52 is manufactured from a fourth predetermined material and has a fifth predetermined size and a fifth predetermined shape.

It is presently preferred that such cleaning and fluid dispensing apparatus 10 further includes a hanging means 54 disposed on at least one of such housing member 12 and such handle member 14. It is further presently preferred that such hanging means 54 includes a braided metal hang wire 56.

It is presently preferred that such cleaning and fluid dispensing device 10 further includes an o-ring remover 58 at least one of disposed thereon and releasably attached thereto at a predetermined location. It is presently preferred that such o-ring remover 58 is releasably attached to such hanging means 54. However, the device 10 is not meant to be limited as such and the o-ring remover may be formed integrally with such device 10.

It is presently preferred that such device 10 further includes at least one tooth type member 33 disposed on at least one of such handle member 14 and such housing member 12 at a sixth predetermined location thereon. Such at least one tooth type member may also be used to facilitate removal of o-rings and the like.

It is presently preferred that such cleaning and fluid dispensing device 10 further includes at least one magnet 62 operably disposed on a predetermined portion of at least one of such housing member 12 and such handle member 14 such that such device 10 can be releasably attached to a predetermined metal surface via magnetic attraction.

It is presently preferred that such cleaning and fluid dispensing device 10 further includes a second plurality of brush bristles 66 operably disposed at a fifth predetermined location thereon. Such second plurality of brush bristles 66 being manufactured from a fifth predetermined material and having a second predetermined length.

According to another embodiment, a method of using a cleaning and fluid dispensing device is provided. Such method includes the steps of providing a cleaning and fluid dispensing device including: a housing member manufactured from a first predetermined material and having a first predetermined size and a first predetermined shape; a first plurality of brush bristles operably connected to such housing member at a first predetermined location thereon, such plurality of brush bristles being manufactured from a second predetermined material and having a first predetermined length; a handle member operably connected to such housing member at a second predetermined location thereon, such handle member being manufactured from a third predetermined material and having a second predetermined size and a second predetermined shape; a reservoir for storing a predetermined amount of a predetermined fluid, such reservoir being within at least one of such housing member, such handle member, and a combination thereof and having a fourth predetermined size and a fourth predetermined shape; an access means in fluid communication with such reservoir and operably connected to at least one of such housing member and such handle member at a third predetermined location thereon for selectively accessing such reservoir such that such reservoir may be at least one of filled, emptied, refilled and a combination thereof. Filling such reservoir with such predetermined amount of such predetermined liquid. Brushing a surface of a predetermined item to be cleaned. Dispensing a second predetermined amount of such predetermined liquid on such surface of such predetermined item.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A cleaning and fluid dispensing device comprising:
a. a housing member manufactured from a first predetermined material and having a first predetermined size and a first predetermined shape;
b. a first plurality of brush bristles operably connected to said housing member at a first predetermined location thereon, said plurality of brush bristles being manufactured from a second predetermined material and having a first predetermined length;
c. a handle member operably connected to said housing member at a second predetermined location thereon, said handle member being manufactured from a third predetermined material and having a second predetermined size and a second predetermined shape;
d. a reservoir for storing a predetermined amount of a predetermined fluid, said reservoir being disposed within at least one of said housing member, said handle member and a combination thereof, said reservoir having a third predetermined size and a third predetermined shape; and
e. an access means in fluid communication with said reservoir and operably connected to at least one of said housing member and said handle member at a third predetermined location thereon for selectively accessing said reservoir such that said reservoir may be at least one of filled, emptied, refilled and a combination thereof.

2. A cleaning and fluid dispensing device according to claim 1 wherein said access means is a screw on cap and wherein at least one of said handle member and said housing member includes a raised opening being threaded around an outer perimeter thereof and said screw on cap includes a threaded female opening for screwing onto said threaded outer perimeter of said raised opening.

3. A cleaning and fluid dispensing device according to claim 2 wherein said screw on cap further includes a flip top cap hingedly connected thereto at a first predetermined location thereon for moving between a closed position generally parallel to said screw on cap wherein a top portion of said screw on cap is covered by said flip top cap and an open position generally perpendicular to said screw on cap wherein top portion of said screw on cap is uncovered, said screw on cap further including an aperture disposed through said top portion thereof at a second predetermined location thereon, said aperture being covered by said flip top cap when said flip top cap is in said closed position such that such predetermined fluid is retained within said reservoir and said aperture being uncovered for dispensing such predetermined fluid there from when said flip top cap is in said open position.

4. A cleaning and fluid dispensing device according to claim 1 wherein said reservoir extends through a predetermined portion of said housing member and a predetermined portion of said handle member.

5. A cleaning and fluid dispensing device according to claim 4 wherein at least one of said housing member and said handle member includes a generally transparent member disposed at a fourth predetermined location thereon such that said predetermined fluid is at least partially visible through said generally transparent member, said generally transparent member being manufactured from a fourth predetermined material and having a fifth predetermined size and a fifth predetermined shape.

6. A cleaning and fluid dispensing device according to claim 1 wherein said cleaning and fluid dispensing apparatus further includes a hanging means disposed on at least one of said housing member and said handle member.

7. A cleaning and fluid dispensing device according to claim 6 wherein said hanging means includes a braided metal hang wire.

8. A cleaning and fluid dispensing device according to claim 1 wherein said first predetermined material is plastic.

9. A cleaning and fluid dispensing device according to claim 1 wherein said second predetermined material is metal.

10. A cleaning and fluid dispensing device according to claim 1 wherein said third predetermined material is plastic.

11. A cleaning and fluid dispensing device according to claim 1 wherein said first predetermined material and said third predetermined material are substantially identical.

12. A cleaning and fluid dispensing device according to claim 1 wherein said reservoir is sized to hold between about ¼ quart and about ¾ quart of said predetermined fluid.

13. A cleaning and fluid dispensing device according to claim 1 wherein said cleaning and fluid dispensing device further includes an o-ring remover at least one of disposed thereon and releasably attached thereto at a predetermined location thereon.

14. A cleaning and fluid dispensing device according to claim 6 wherein said cleaning and fluid dispensing device further includes an o-ring remover releasably attached to said hanging means.

15. A cleaning and fluid dispensing device according to claim 1 wherein said cleaning and fluid dispensing device further includes at least one magnet operably disposed on a predetermined portion of at least one of said housing member and said handle member such that said device can be releasably attached to a predetermined metal surface via magnetic attraction.

16. A cleaning and fluid dispensing device according to claim 1 wherein said handle member includes at least one molded fingergrip at a predetermined location thereon.

17. A cleaning and fluid dispensing device according to claim 1 wherein said cleaning and fluid dispensing device further includes a second plurality of brush bristles operably disposed at a fifth predetermined location thereon, said second plurality of brush bristles being manufactured from a fifth predetermined material and having a second predetermined length.

18. A cleaning and fluid dispensing device according to claim 17 wherein said access means is disposed on said handle member.

19. A cleaning and fluid dispensing device according to claim 1 wherein said device further includes at least one tooth type member disposed on at least one of said handle member and said housing member at a sixth predetermined location thereon.

20. A method of using a cleaning and fluid dispensing device comprising the steps of:
a. providing a cleaning and fluid dispensing device including;
i. a housing member manufactured from a first predetermined material and having a first predetermined size and a first predetermined shape;
ii. a first plurality of brush bristles operably connected to said housing member at a first predetermined location thereon, said plurality of brush bristles being manufactured from a second predetermined material and having a first predetermined length;
iii. a handle member operably connected to said housing member at a second predetermined location thereon, said handle member being manufactured from a third predetermined material and having a second predetermined size and a second predetermined shape;
iv. a reservoir for storing a predetermined amount of a predetermined fluid, said reservoir being within at least one of said housing member, said handle member, and a combination thereof and having a fourth predetermined size and a fourth predetermined shape;
v. an access means in fluid communication with said reservoir and operably connected to at least one of said housing member and said handle member at a third predetermined location thereon for selectively accessing said reservoir such that said reservoir may be at least one of filled, emptied, refilled and a combination thereof; and
b. filling said reservoir with such predetermined amount of such predetermined liquid;
c. brushing a surface of a predetermined item to be cleaned; and
d. dispensing a second predetermined amount of such predetermined liquid on such surface of such predetermined item.
